(19) United States
(12) Patent Application Publication
(10) Pub. No.: US 2004/0160383 A1
(43) Pub. Date: Aug. 19, 2004

(54) Multi-screen driving device and method

(76) Inventor: Yung-Chi Wen, Hsinchu (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/751,261

(22) Filed: Jan. 2, 2004

(30) Foreign Application Priority Data
Jan. 2, 2003 (TW) 092100026

(51) Int. Cl. G09G 5/00

(52) U.S. Cl. 345/1.1; 345/204

(57) ABSTRACT

A multi-screen driving device is used in an electrical appliance. The multi-screen driving device includes a control unit, an application specific integrated circuit and a first and a second screens. The control unit is used for outputting a plurality of display data including first display data and second display data, and asserting a set of control signals. The application specific integrated circuit is in communication with the control unit for distinguishing the plurality of display data as the first or the second display data in response to the set of control signals. The first and the second screens are both in communication with the application specific integrated circuit for displaying the first and the second display data, respectively.

### FIELD OF THE INVENTION

The present invention relates to a multi-screen driving device, and more particularly to a multi-screen driving device for used in a portable electrical appliance. The present invention also relates to a displaying method of an electrical appliance having multiple screens.

### BACKGROUND OF THE INVENTION

Recently, planar display and portable electrical apparatus such as notebook, cellular phone and personal digital assistant (PDA), are rapidly developed toward miniaturization. In addition, these electrical apparatus have stronger functions than the prior art. Taking a cellular phone for example, a colorful screen, in place of the monochrome one, becomes as essential. On the other hand, dual-screen cellular phones are developed in recent years to provide an alternative choice in addition to single-screen ones.

Please refer to FIG. 1, which is a schematic circuit block diagram illustrating a driving device of a conventional dual-screen cellular phone. The driving device comprises a central processing unit (CPU) 100 for controlling operations of related components. Under the control of the CPU 100, displayed data and control signals are transmitted to a first latch unit 110 via a first bus 102. In response to the control signals, the displayed data are transmitted to a first screen 130 for display by a first application specific integrated circuit (ASIC) 120. Likewise, via a second bus 104, displayed data and control signals are transmitted to a first latch unit 140. In response to the control signals, the displayed data are transmitted to a second screen 160 for display by a second application specific integrated circuit (ASCI) 150.

FIG. 2 is a timing waveform diagram illustrating related signals processed in the driving device of FIG. 1. In this waveform diagram, CKV1 and CKV2 are reference clock signals of the whole driving device and each has a frequency Fcr. The signal CKH1/2 is derived from these reference clock signals and has a frequency Fc, where Fc=N×Fcr. The high-level states of a signal DE indicates a row invalid data period. The signal ENBH is derived from the signal CKH1/2 for being referred to receive display data during the invalid data period. The signals STH and STV are row initiating signal and frame initiating signal, respectively.

Take a cellular phone screen having resolution m*n as an example. The screen could display an image frame consisting of m columns and n rows of pixels, as shown in FIG. 3. In response to the frame initiating signal (STV) 11, the whole image frame is to be refreshed. Then, a series of row initiating signal (STH) 21, 22, . . . , 2n are asserted to refresh the image frame row by row. For example, in response to the row initiating signal (STH) 21, a row 31 of data starts to be refreshed. The refreshed row data 31 consisting of m pixels are received and displayed during the row valid data period 41 indicated by the high-level state of the signal DE by referring to the signal (ENBH) 51. When the row initiating signal (STH) 22 is subsequently asserted, next row 32 of data consisting of other m pixels are received and displayed on the screen. By this way, the display data are refreshed row by row until the final row 3n of data are received and displayed. After a predetermined period of void time, another frame initiating signal (STV) 12 is asserted to start the display of next frame.

The above-mentioned procedures are performed by an application specific integrated circuit (ASIC) designed for this object, and the assertion of the signals CKV1, CKV2, CKH1/2, DE, STH, ENBH and STV varies with the resolution of the screen.

It is known that all the screens of cellular phones fabricated by different manufactures are not identical. For the purpose of fitting various screens with different resolution, the CPU generally outputs data displayed with a larger resolution than required. The ASIC then picks up a proper portion of the data to be displayed according to desired resolution. As shown in FIG. 4, for example, p image data are outputted by the CPU, where p>m, between two adjacent STH signal pulses, and q STH signal pulses indicating q rows of data appear between two adjacent STV signals, where q>n. Afterwards, the image data displayed with a resolution m*n will be picked up by the application specific integrated circuit and displayed.

As previously described in FIG. 1, for a conventional dual-screen cellular phone, two application specific integrated circuits 120 and 150 are required to receive display data transmitted via the buses 102 and 104. With such configuration, the layout of the related circuits might occupy much space and be costly due to the necessity of two application specific integrated circuits. Therefore, such layout is disadvantageous for miniaturization of the commercial product. Moreover, the image data outputted by the CPU but unpicked by the application specific integrated circuits are discarded so as to result in efficiency lost.

### SUMMARY OF THE INVENTION

Therefore, it is an object of the present invention to provide a multi-screen driving device using a single application specific integrated circuit to achieve the purpose of multi-screen display so as to reduce area and cost of layout.

It is another object of the present invention to provide a method for driving a multi-screen electrical appliance to make use of the data outputted by the CPU but unpicked by the ASIC.

In accordance with a first aspect of the present invention, there is provided a multi-screen driving device for use in an electrical appliance. The multi-screen driving device comprises a control unit, an application specific integrated circuit and a first and a second screens. The control unit is used for outputting a plurality of display data comprising first display data and second display data, and asserting a set of control signals. The application specific integrated circuit is in communication with the control unit for distinguishing the plurality of display data as the first or the second display data in response to the set of control signals. The first and the second screens are both in communication with the application specific integrated circuit for displaying the first and the second display data, respectively.

In an embodiment, the application specific integrated circuit outputs the first and the second display data to the first and the second screen, respectively, according to a time-division multiplexing procedure.

In an embodiment, the multi-screen driving device further comprises a latch unit electrically connected between the control unit and the application specific integrated circuit for latching and then outputting the first and the second display data and the set of control signals to the application specific integrated circuit.

In an embodiment, the first display data and the second display data are different data. Alternatively, a portion of the first display data and a portion of the second display data are identical data, and simultaneously outputted to both of the first and the second screens.

In an embodiment, the control unit is a central processing unit (CPU).

In an embodiment, the electrical appliance is a cellular phone.

In accordance with a second aspect of the present invention, there is provided a multi-screen driving device for use in a cellular phone. The multi-screen driving device comprises a control unit, an application specific integrated circuit, a latch unit and a first and a second screens. The control unit is used for outputting a plurality of display data comprising first display data and second display data, and asserting a set of control signals. The application specific integrated circuit is in communication with the control unit for distinguishing the plurality of display data as the first or the second display data in response to the set of control signals according to a time-division multiplexing procedure. The latch unit is electrically connected between the control unit and the application specific integrated circuit for latching and then outputting the first and the second display data and the set of control signals to the application specific integrated circuit. The first and the second screens are both in communication with the application specific integrated circuit for displaying the first and the second display data, respectively.

In accordance with a third aspect of the present invention, there is provided a multi-screen driving method for use in an electrical appliance having a first and a second screens. The method comprises the following steps. Firstly, a set of control signals and a plurality of display data comprising first display data and second display data to be revealed are received by the first and the second screens, respectively. Then, in response to the set of control signals, a time-division multiplexing procedure is performed to output the first and the second data to the first and the second screens, respectively.

In an embodiment, the first and the second display data are outputted by a central processing unit (CPU) in a frame, and the frame has a resolution greater than that of each of the first and the second screens.

In an embodiment, the time-division multiplexing procedure is performed in a single application specific integrated circuit.

In an embodiment, each of the plurality of display data is verified as the first display data or the second display data in response to one of the control signals.

In an embodiment, the set of control signals includes a clock signal to be referred to output the plurality of display data.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating a driving device of a conventional dual-screen cellular phone;

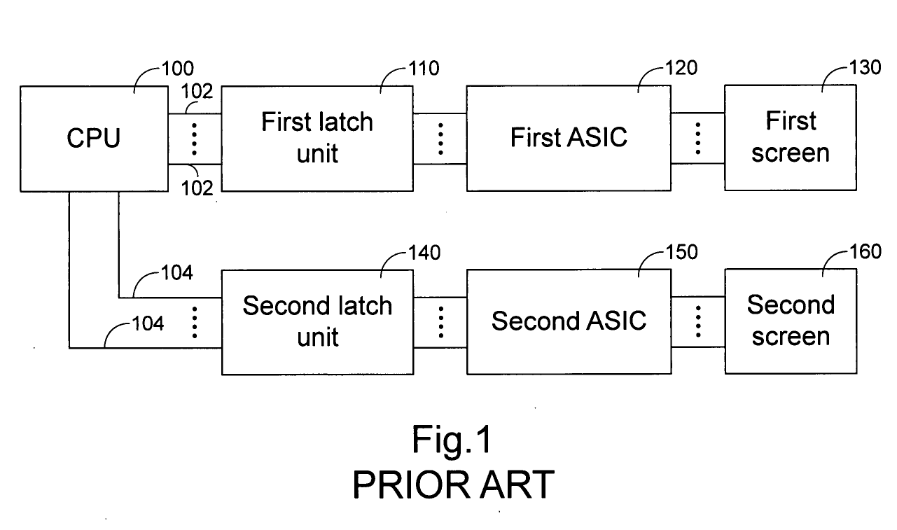

FIG. 2 is a timing waveform diagram illustrating related signals processed in the driving device of FIG. 1;

FIG. 3 is a diagram that schematically illustrates the data to be shown on one of the screens in response to the initiating signals STV and STH according to prior art;

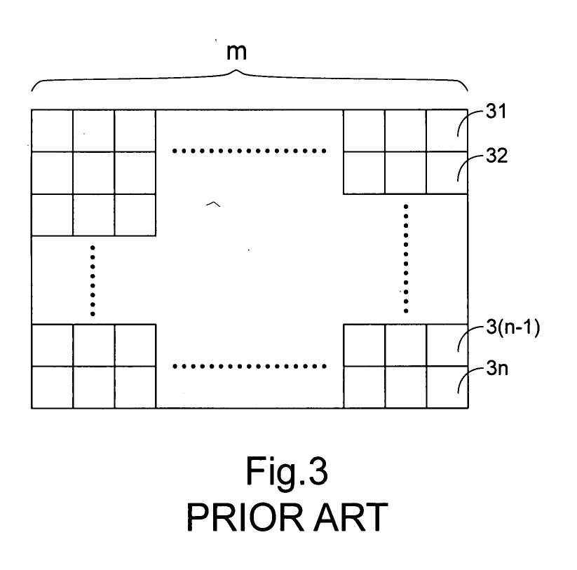

FIG. 4 is a diagram that schematically illustrates the data outputted by the CPU to be shown on the screen of FIG. 3 in response to the initiating signals STV and STH according to the prior art;

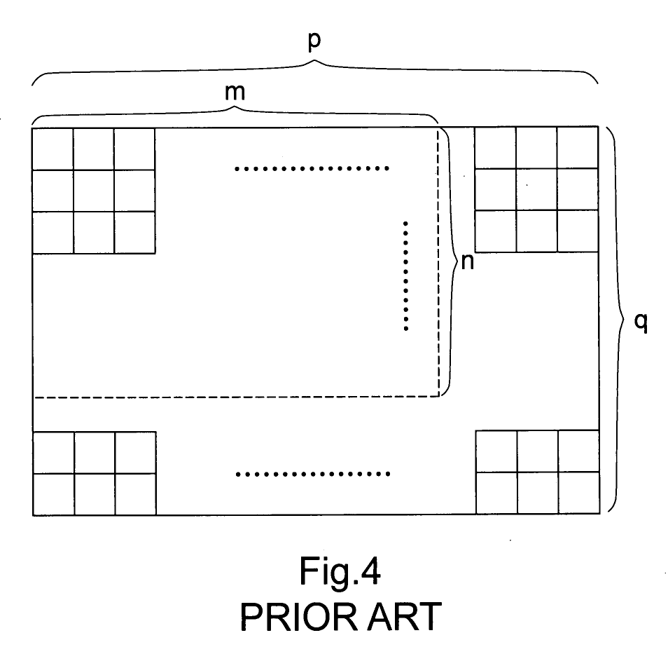

FIG. 5 is a schematic block diagram of a driving device for use in a dual-screen cellular phone according to an embodiment of the present invention;

FIG. 6 is a diagram that schematically illustrates the data outputted by the CPU to be displayed on two screens of a dual-screen cellular phone according to an example of the present invention; and

FIG. 7 is a diagram that schematically illustrates the data outputted by the CPU to be displayed on two screens of a dual-screen cellular phone according to another example of the present invention.

### DETAILED DESCRIPTION OF THE PREFERRED EMBODIMENT

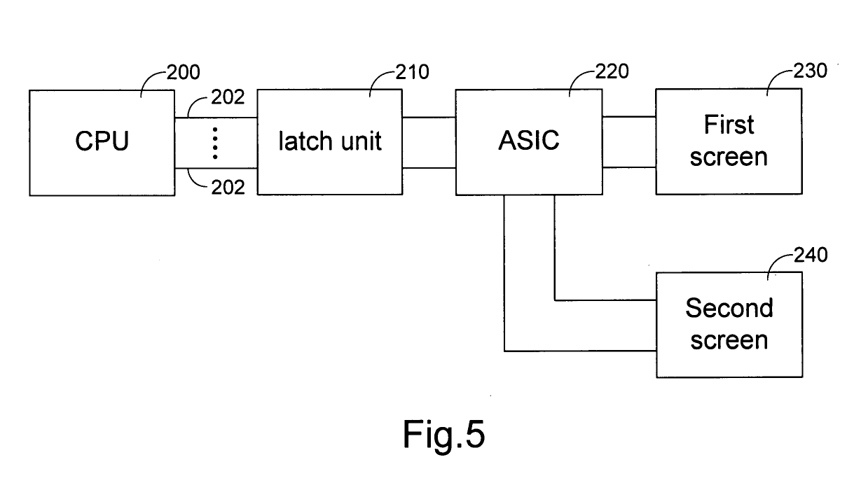

FIG. 5 is a schematic block diagram illustrating a driving device of a dual-screen cellular phone according to the present invention. The driving device comprises a central processing unit (CPU) 200, a latch unit 210, an application specific integrated circuit (ASIC) 220, a first screen 230 and a second screen 240. The CPU 200 is used for controlling operations of related components. Under the control of the CPU 200, displayed signals and control signals are transmitted to the latch unit 210 via a bus 202. In response to the control signals, the displayed signals are transmitted to the first screen 230 and the second screen 240 by the ASIC 220.

The CPU 200 outputs data displayed with a larger resolution than required. The ASIC 220 designed for the present purpose then picks up and transmits a first proper portion of the data by means of a time division multiplexing (TDM) procedure to the first screen 230 and a second proper portion of the data to the second screen 240 for display. The portions of the data to be transmitted to the first and the second screens 230 and 240, respectively, will be described hereinafter.

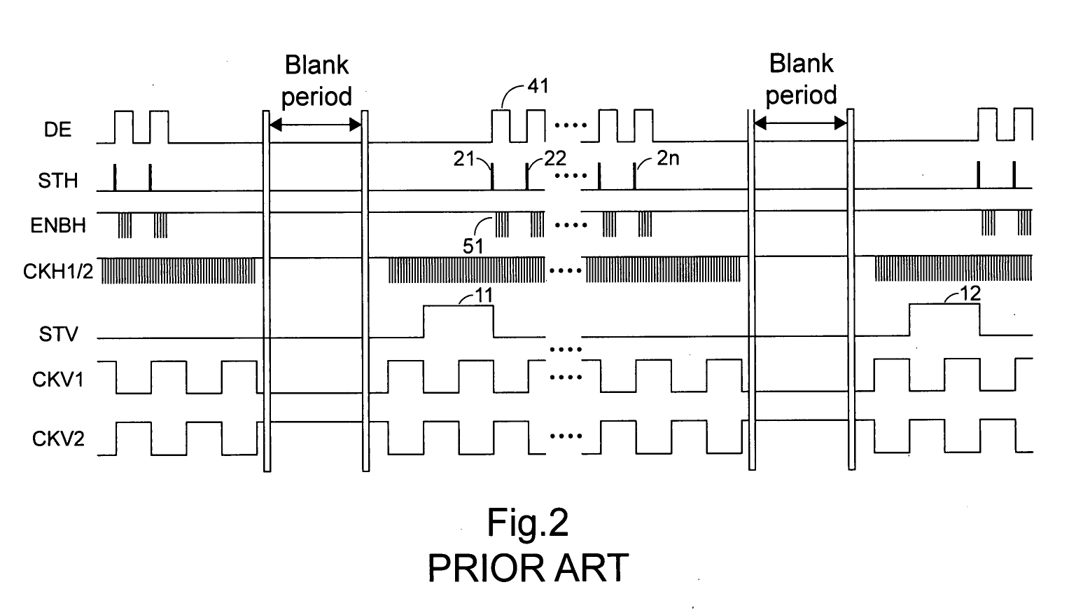

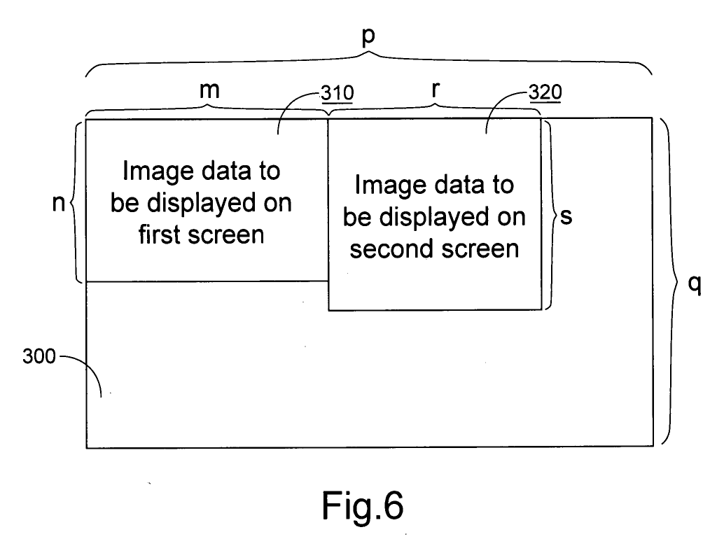

For example, if the image data 310 and 320 to be displayed on the screens 230 and 240 have resolutions m*n and r*s, respectively, the CPU 200 outputs image data 300 consisting of p columns and q rows, where p>m+r, q>n and q>s, as shown in FIG. 6. The transmission timing of the data will be described in detail with reference to the signals of FIG. 2. Between the two adjacent STH signal pulses 21 and 22, m+r entries of data for a row are picked up by the application specific integrated circuit 220, wherein the continuous m entries and then the continuous r entries of data are displayed on the screens 230 and 240 as respective rows. In this embodiment, the high-level and the low-level states of the signal DE indicate row valid data periods for the screens 230 and 240, respectively. According to such protocol, the image data 310 and 320 displayed with resolutions m*n and r*s will be picked up by the application specific integrated circuit 220 and displayed on the screens 230 and 240, respectively.

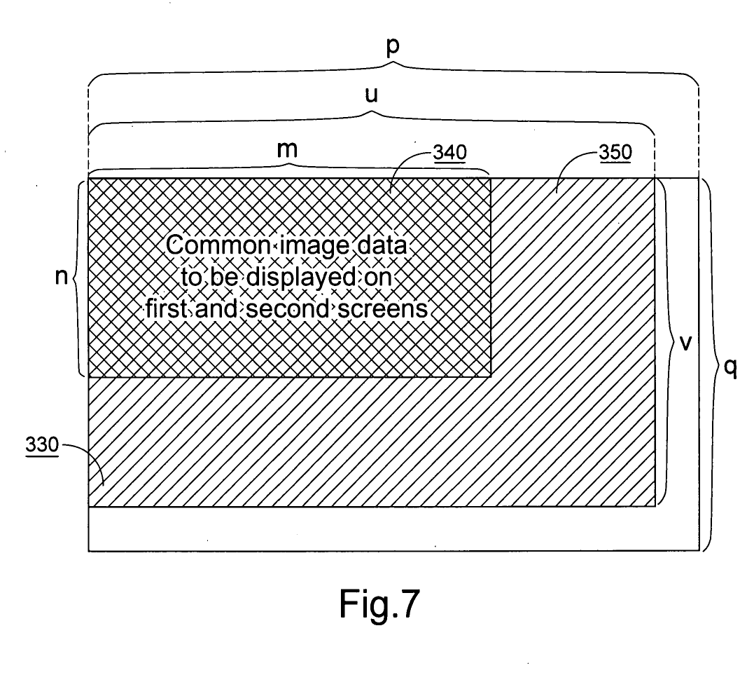

In a case that the two screens 230 and 240 display identical image frames, the image data outputted by the CPU 200 can be transmitted to both screens 230 and 240 by the ASIC 220. Alternatively, the screen 230 or 240 may display a portion 340 of the image frame 350 to be displayed by the other screen 240 or 230, as shown in FIG. 7. For example, image data 330 consisting of p columns and q rows are outputted by the CPU 200. The first continuous m entries of data are transmitted to both of the screens 230 and 240 by the ASIC 220. Then, the continuous (m+1)˜u entries of data are further transmitted to the screen 230 or 240. The above procedures are repeated row by row. By this way, the image data 340 and 350 to be displayed on the screens 230 and 240 have resolutions m*n and u*v. By means of a single ASIC 220 according to the present invention, the image data 340 and 350 can be picked up and displayed on the screens 230 and 240 with resolutions m*n and u*v. In practice, the common items to be displayed on both screens can be time, name of system supplier, content of battery power, etc.

According to the present invention, it is required that p*q is no smaller than (m+r)*n or (m+r)*s in the example of FIG. 6 or no smaller than u*v in the example of FIG. 7. Therefore, if necessary, the frequency of the signal CKH1/2 can be suitably adjusted, i.e. increased, for a purpose of making sure that the data outputted by the CPU is sufficient for providing for the display of the two screens by increasing p*q to be larger than required.

Since only a single ASIC is used to pick up respective portions of the image data for two or more screens by means of a time division multiplexing procedure, much layout area will be saved. Therefore, the volume and the cost of the multi-screen electrical appliance such as the dual-screen cellular phone can be effectively reduced. Furthermore, since the feature that the CPU conventionally outputs a larger resolution of data than required is utilized, the outputted but unpicked data capacity of the CPU can be made use of by way of the time division multiplexer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-screen driving device for use in an electrical appliance, comprising:
a control unit for outputting a plurality of display data comprising first display data and second display data, and asserting a set of control signals;
an application specific integrated circuit in communication with said control unit for distinguishing said plurality of display data as said first or said second display data in response to said set of control signals; and
a first and a second screens both in communication with said application specific integrated circuit for displaying said first and said second display data, respectively.

2. The multi-screen driving device according to claim 1 wherein said application specific integrated circuit outputs said first and said second display data to said first and said second screen, respectively, according to a time-division multiplexing procedure.

3. The multi-screen driving device according to claim 1 further comprising a latch unit electrically connected between said control unit and said application specific integrated circuit for latching and then outputting said first and said second display data and said set of control signals to said application specific integrated circuit.

4. The multi-screen driving device according to claim 1 wherein said first display data and said second display data are different data.

5. The multi-screen driving device according to claim 1 wherein a portion of said first display data and a portion of said second display data are identical data, and simultaneously outputted to both of said first and said second screens.

6. The multi-screen driving device according to claim 1 wherein said control unit is a central processing unit (CPU).

7. The multi-screen driving device according to claim 1 wherein said electrical appliance is a cellular phone.

8. A dual-screen driving device for use in a cellular phone, comprising:
a control unit for outputting a plurality of display data comprising first display data and second display data, and asserting a set of control signals;
an application specific integrated circuit in communication with said control unit for distinguishing said plurality of display data as said first or said second display data in response to said set of control signals according to a time-division multiplexing procedure;
a latch unit electrically connected between said control unit and said application specific integrated circuit for latching and then outputting said first and said second display data and said set of control signals to said application specific integrated circuit; and
a first and a second screens both in communication with said application specific integrated circuit for displaying said first and said second display data, respectively.

9. A multi-screen driving method for use in an electrical appliance having a first and a second screens, said method comprising steps of:
receiving a set of control signals and a plurality of display data comprising first display data and second display data to be revealed by said first and said second screens, respectively; and
performing a time-division multiplexing procedure to output said first and said second data to said first and said second screens, respectively, in response to said set of control signals.

10. The method according to claim 9 wherein said first and said second display data are outputted by a central processing unit (CPU) in a frame, and said frame has a resolution greater than that of each of said first and said second screens.

11. The method according to claim 9 wherein said first display data and said second display data are different data.

12. The method according to claim 9 wherein a portion of said first display data and a portion of said second display data are identical data, and simultaneously outputted to both of said first and said second screens.

13. The method according to claim 9 wherein said time-division multiplexing procedure is performed in a single application specific integrated circuit.

14. The method according to claim 9 wherein each of said plurality of display data is verified as said first display data or said second display data in response to one of said control signals.

15. The method according to claim 9 wherein said set of control signals includes a clock signal to be referred to output said plurality of display data.

16. The method according to claim 9 wherein said electrical appliance is a cellular phone.
